(19) United States
(12) Patent Application Publication
(10) Pub. No.: US 2023/0354401 A1
(43) Pub. Date: Nov. 2, 2023

(54) CG HARQ-ACK ENHANCEMENTS

(71) Applicant: QUALCOMM Incorporated, San Diego, CA (US)

(72) Inventors: Ahmed ELSHAFIE, San Diego, CA (US); Wei YANG, San Diego, CA (US); Yi HUANG, San Diego, CA (US); Hung Dinh LY, San Diego, CA (US)

(21) Appl. No.: 17/661,269

(22) Filed: Apr. 28, 2022

(51) Int. Cl. H04L 1/18; H04W 72/10; H04W 72/04; H04L 5/00

(52) U.S. Cl. CPC H04W 72/10; H04L 1/1812; H04L 5/0053; H04W 72/042; H04W 72/0453

(57) ABSTRACT

An apparatus may be configured to receive an indication activating a set of periodic resources in a plurality of CCs for a HARQ codebook, identify information associated with a set of canceled HARQ bits, select at least one CC in the plurality of CCs for transmitting the information associated with a HARQ bit in the set of canceled HARQ bits, and transmit the information associated with the set of canceled HARQ bits to a network node via the at least one CC. The apparatus may be configured to transmit an indication activating a set of periodic resources in a plurality of CCs for a HARQ codebook and receive information associated with a set of canceled HARQ bits from a network node (e.g., a UE) via at least one CC in the plurality of CCs.

### TECHNICAL FIELD

The present disclosure relates generally to communication systems, and more particularly, to a hybrid automatic repeat request (HARQ) feedback codebook.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to receive an indication activating a set of periodic resources in a plurality of component carriers (CCs) for a HARQ codebook. The apparatus may also be configured to identify information associated with a set of canceled HARQ bits. The apparatus may further be configured to select at least one CC in the plurality of CCs for transmitting the information associated with a HARQ bit in the set of canceled HARQ bits. The apparatus may be configured to transmit the information associated with the set of canceled HARQ bits to a network node via the at least one CC.

In an aspect of the disclosure, a method, a computer-readable medium, and an apparatus are provided. The apparatus may be configured to transmit an indication activating a set of periodic resources in a plurality of CCs for a HARQ codebook. The apparatus may further be configured to receive information associated with a set of canceled HARQ bits from a network node (e.g., a user equipment (UE)) via at least one CC in the plurality of CCs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating a set of occasions for DL data associated with a PUCCH resource for transmitting HARQ-acknowledgment (ACK)/negative ACK (NACK) for the PDSCH occasions.

FIG. 4B is a diagram illustrating a network node being configured with periodic resources for having semi-persistent scheduling (SPS) resources activated.

FIG. 5 is a diagram illustrating a PUCCH group including multiple CCs.

FIG. 6 is a call flow diagram illustrating a set of communications for which the type-3 HARQ codebook may be implemented.

FIG. 7 is a diagram illustrating a HARQ associated with a DL data that is received after a type-3 HARQ trigger being transmitted in a type-3 PUCCH associated with the type-3 HARQ trigger.

FIG. 8 is a flowchart of a method of wireless communication.

FIG. 9 is a flowchart of a method of wireless communication.

FIG. 10 is a diagram illustrating an example of a hardware implementation for an apparatus.

FIG. 11 is a diagram illustrating an example of a hardware implementation for a network entity.

### DETAILED DESCRIPTION

In some aspects, of wireless communication a mechanism or method for HARQ-ACK feedback may be implemented that allows for a network entity to request feedback of a HARQ-ACK codebook containing all DL HARQ processes (e.g., one-shot feedback) for all CCs configured for a UE in the PUCCH group. In some aspects, the mechanism allows the network entity to recover information related to one or more failed HARQ-ACK feedback transmissions due to listen -before-talk (LBT) based failures. Similarly, in the presence of different types of feedback and other transmissions with different priorities canceled feedback transmissions become more frequent. However, different types of communications, e.g., URLLC, may specify low latency that may not be achieved by request-based feedback from a network entity (e.g., a base station) that first identifies that feedback was not received and then may make a request for the feedback. Accordingly, the apparatus and method presented herein provides a mechanism for reducing the latency of the identification and selection of resources associated with missed HARQ feedback.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

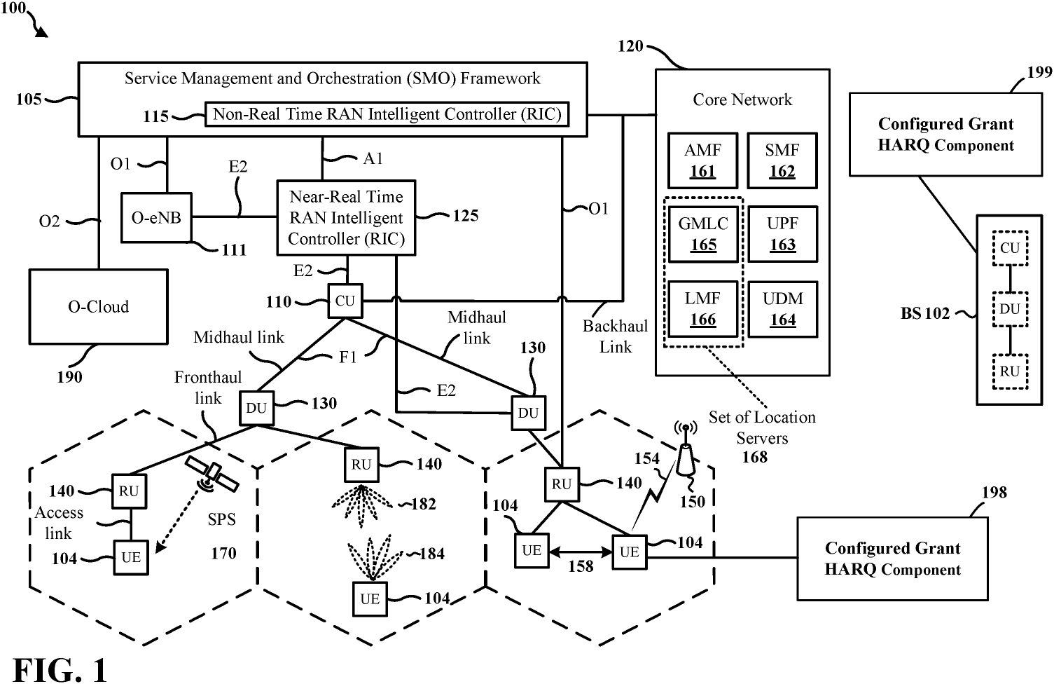

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit - User Plane (CU-UP)), control plane functionality (i.e., Central Unit - Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI) / machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102 / UEs 104 may use spectrum up to Y MHz (e.g., 5, 10, 15, 20, 100, 400, etc. MHz) bandwidth per carrier allocated in a carrier aggregation of up to a total of Yx MHz (x CCs) used for transmission in each direction. The carriers may or may not be adjacent to each other. Allocation of carriers may be asymmetric with respect to DL and UL (e.g., more or fewer carriers may be allocated for DL than for UL). The CCs may include a primary CC and one or more secondary CCs. A primary CC may be referred to as a primary cell (PCell) and a secondary CC may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104 / AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz - 7.125 GHz) and FR2 (24.25 GHz - 52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz - 71 GHz), FR4 (71 GHz - 114.25 GHz), and FR5 (114.25 GHz - 300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102 / UE 104 may perform beam training to determine the best receive and transmit directions for each of the base station 102 / UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a configured grant HARQ component 198 that may be configured to receive an indication activating a set of periodic resources in a plurality of CCs for a HARQ codebook, identify information associated with a set of canceled HARQ bits, select at least one CC in the plurality of CCs for transmitting the information associated with a HARQ bit in the set of canceled HARQ bits, and transmit the information associated with the set of canceled HARQ bits to a network node via the at least one CC. In certain aspects, the base station 102 may include a configured grant HARQ component 199 that may be configured to transmit an indication activating a set of periodic resources in a plurality of CCs for a HARQ codebook and receive information associated with a set of canceled HARQ bits from a network node (e.g., a UE) via at least one CC in the plurality of CCs. Although the following description may be focused on 5G NR, the concepts described herein may be applicable to other similar areas, such as LTE, LTE-A, CDMA, GSM, and other wireless technologies.

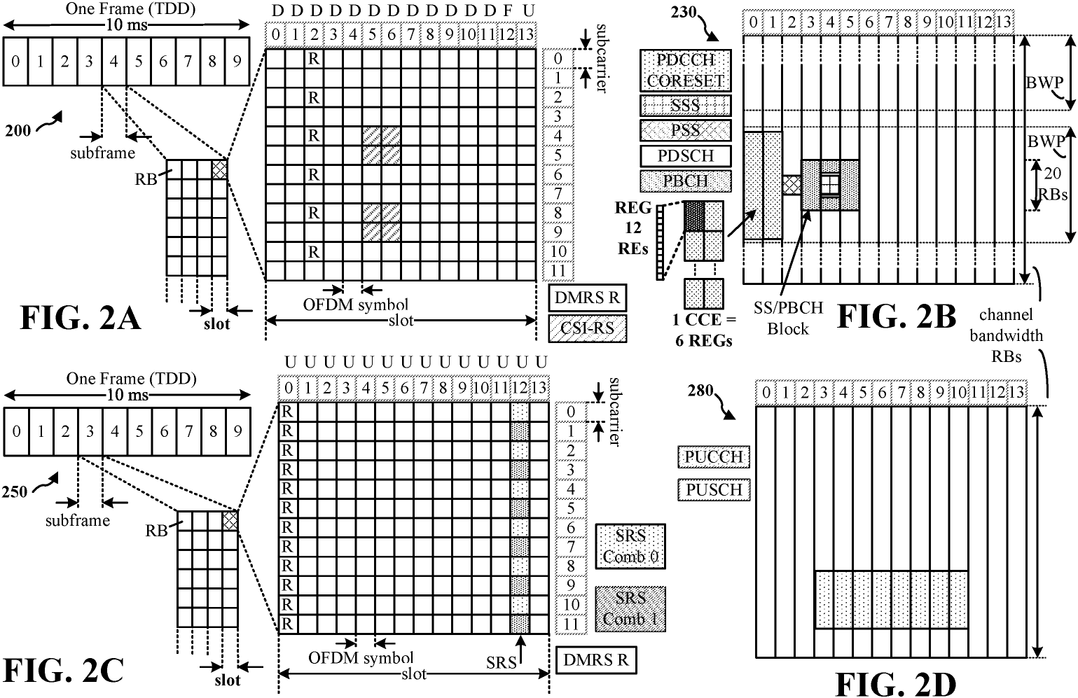

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| µ | SCS Δ f = 2^{µ}▪ 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies µ 0 to 4 allow for 1, 2, 4, 8, and 16 slots, respectively, per subframe. For extended CP, the numerology 2 allows for 4 slots per subframe. Accordingly, for normal CP and numerology µ, there are 14 symbols/slot and 2^{µ} slots/subframe. The subcarrier spacing may be equal to 2^{µ} _{*} 15 kHz, where µ is the numerology 0 to 4. As such, the numerology µ=0 has a subcarrier spacing of 15 kHz and the numerology µ=4 has a subcarrier spacing of 240 kHz. The symbol length/duration is inversely related to the subcarrier spacing. FIGS. 2A-2D provide an example of normal CP with 14 symbols per slot and numerology µ=2 with 4 slots per subframe. The slot duration is 0.25 ms, the subcarrier spacing is 60 kHz, and the symbol duration is approximately 16.67 µs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

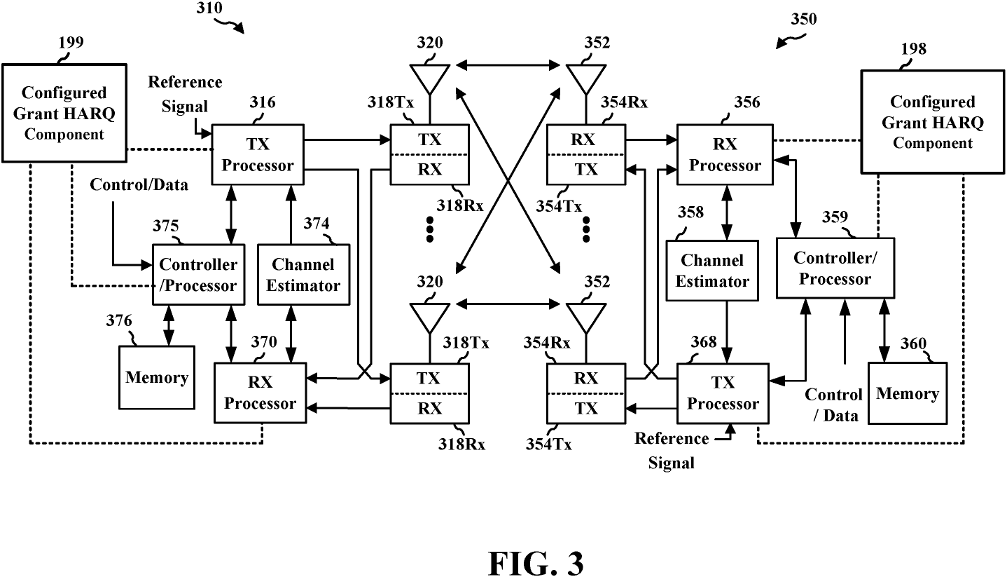

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression / decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression / decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the configured grant HARQ component 198 of FIG. 1. At least one of the TX processor 316, the RX processor 370, and the controller/processor 375 may be configured to perform aspects in connection with the configured grant HARQ component 199 of FIG. 1.

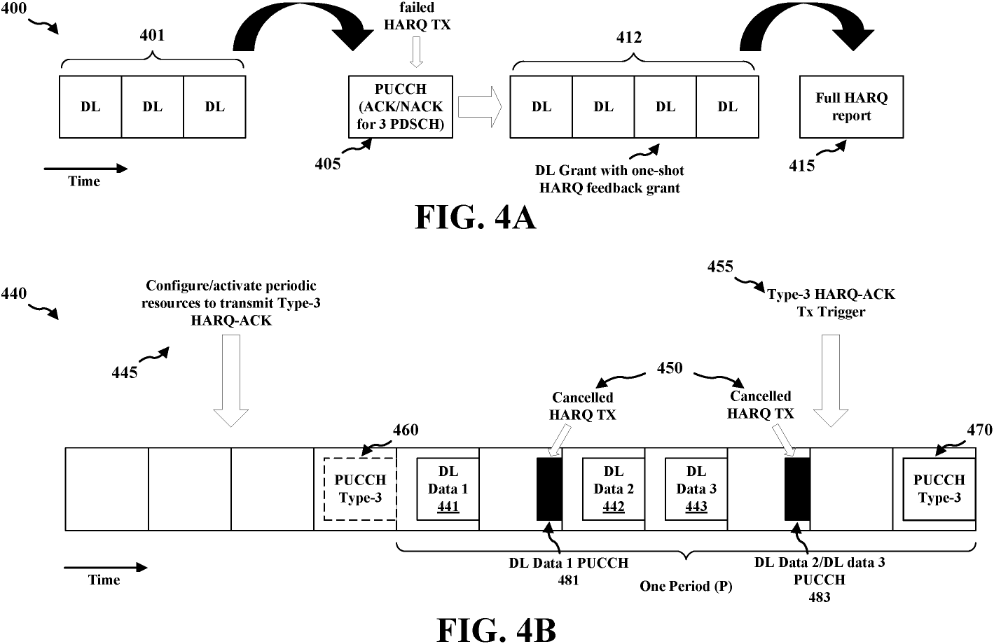

In some aspects, of wireless communication a mechanism or method for HARQ-ACK feedback may be implemented that allows for a network entity to request feedback of a HARQ-ACK codebook containing all DL HARQ processes (e.g., one-shot feedback) for all CCs configured for a UE in the PUCCH group. In some aspects, the mechanism allows the network entity to recover information related to one or more failed HARQ-ACK feedback transmissions due to listen -before-talk (LBT) based failures. FIG. 4A is a diagram 400 illustrating a set of PDSCH occasions 401 for DL data associated with a PUCCH resource 405 for transmitting HARQ-ACK/NACK for the PDSCH occasions 401. As indicated, the HARQ feedback transmission via PUCCH resource 405 may fail. Based on the failure to transmit a threshold number of HARQ feedback bits (e.g., relating to a threshold number of PDSCH occasion), a network node may be triggered to send a full HARQ report 415 for missed (e.g., skipped or canceled) HARQ transmissions (e.g., relating to DL transmissions via PDSCH occasions 401 and/or 412. In some aspects, the triggering may be implemented via (e.g., a trigger may be included in) DCI (e.g., DCI 1_1).

FIG. 4B is a diagram 440 illustrating a network node being configured with periodic resources (e.g., with a SPS configuration) or having SPS resources activated. For example, at 445 a set of periodic resources (with period ‘P’) including a first PUCCH resource 460 and a second PUCCH resource 470 associated with the one-shot, or type-3, HARQ codebook. In some aspects, the SPS resources (or occasions) in one set of periodic resources include PDSCH occasions for DL data 1 441, DL data 2 442, and DL data 3 443, where each PDSCH occasion is associated with a subsequent PUCCH occasion of the SPS resources (e.g., DL data 1 PUCCH occasion 481 or DL data 2/DL data 3 PUCCH occasion 483). Diagram 440 indicates that a HARQ transmission via DL data 1 PUCCH occasion 481 and/or DL data 2/DL data 3 PUCCH occasion 483 may be cancelled, for example, based on the PUCCH overlapping with a (scheduled and/or received) DL symbol. Diagram 440 illustrates that, based on cancelled, at 450, HARQ transmissions associated with DL data 1 441, DL data 2 442, and DL data 3 443, a one-shot, or type-3, HARQ-ACK feedback transmission may be triggered at 455. The trigger may be an explicit trigger (e.g., received from the network entity via RRC signaling, a MAC-CE, or DCI) or an implicit trigger (e.g., a threshold number of missed, e.g., skipped and/or cancelled HARQ transmissions) configured via the configuration and/or activation received at 445. The network node may then transmit HARQ feedback via (type-3) second PUCCH resource 470 relating to the HARQs missed before the trigger.

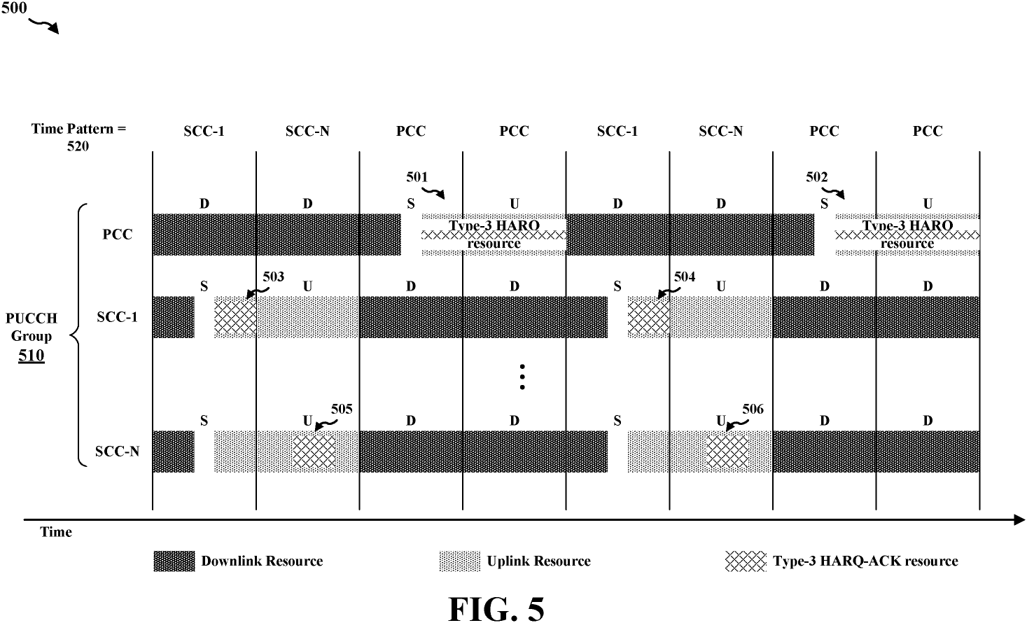

FIG. 5 is a diagram 500 illustrating a PUCCH group 510 including multiple CCs. The multiple CCs may, in some aspects, include a primary CC (PCC), and a set of ‘N’ secondary CCs (SCCs), e.g., SCC-1 to SSC-N. Given the availability of multiple CCs, in some aspects, it may be beneficial to enable selection of different resources for providing one-shot (type-3) HARQ feedback in different CCs as opposed to current implementations which may allow PUCCH to be transmitted in a PCC but do not allow PUCCH to be transmitted in SCCs. FIG. 5 illustrates that resources 501, 502, 503, 504, 505, and 506 for Type-3 HARQ may be distributed across multiple CCs in different slots and/or symbols to ensure availability of resources within a relevant time window. As indicated in FIG. 5, the type-3 resources may be allocated during an UL transmission slot or partial slot. For example, a network entity, such as a base station, may indicate which CC to transmit PUCCH in a slot, via either a new field in DCI (e.g., as part of a dynamic indication) or an RRC-configured time pattern (semi-static, or SPS, indication as illustrated by time pattern 520 of FIG. 5).

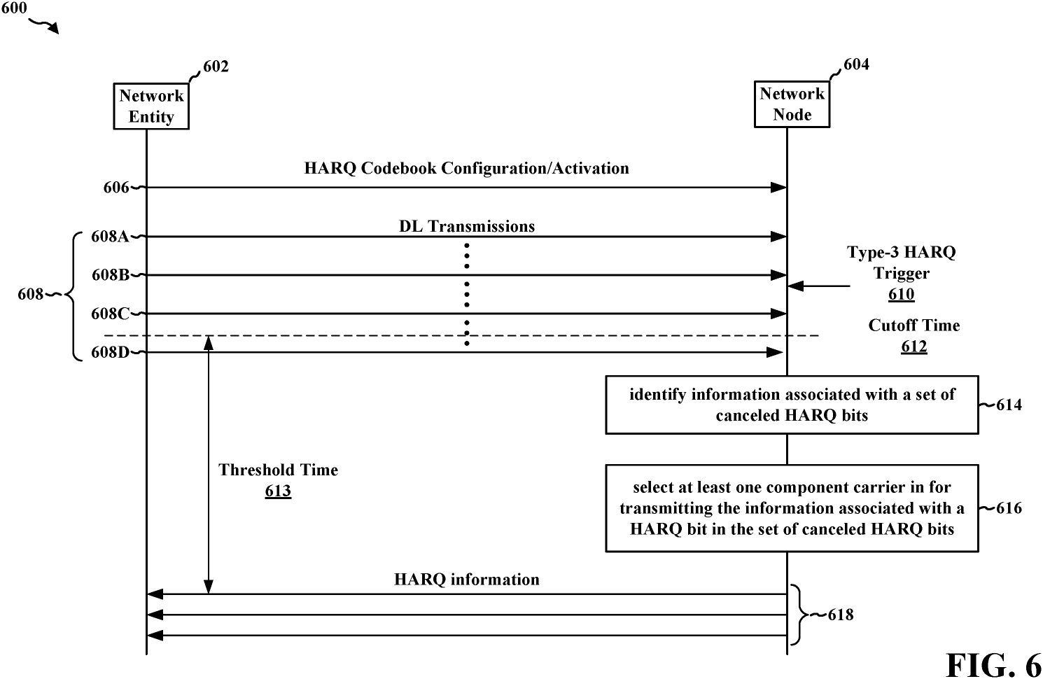

FIG. 6 is a call flow diagram 600 illustrating a set of communications for which the type-3 HARQ codebook may be implemented. Diagram 600 illustrates that a network entity 602 may transmit, and network node 604 may receive, a HARQ codebook configuration/activation 606. The indication, in some aspects, may be transmitted via at least one of RRC signaling, a MAC-CE, or DCI. The activated set of periodic resources may, in some aspects, be associated with a set of data (e.g., DL transmissions 608, including DL transmission 608A, 608B, 608C, and 608D). For example, the indication activating the set of periodic resources may indicate that a first canceled HARQ bit associated with a first priority may be transmitted via a set of ‘X’ resources, a set of ‘X’ UL slots at ‘X’ different times, a set of ‘X’ beams associated with one or more UL slots, and/or a set of ‘X₁’ different UL slots and ‘X₂’ beams such that X = X₁*X₂. The indication activating the set of periodic resources, in some aspects, may indicate that a second canceled HARQ bit associated with a second priority may be transmitted via a set of ‘Y’ resources, a set of ‘Y’ UL slots at ‘Y’ different times, a set of ‘Y’ beams associated with one or more UL slots, and/or a set of ‘Y₁’ different UL slots and ‘Y₂’ beams such that Y = Y₁*Y₂. The set of ‘Y’ UL slots associated with the second priority may be a second-closest in time to the triggering time.

The values of X, X₁, X₂, Y, Y₁, and Y₂, in some aspects, may be configured and/or reconfigured via one or more of RRC signaling, a MAC-CE, or (an activation) DCI. In some aspects, the RRC signaling, MAC-CE, or (activation) DCI may include information regarding resources (e.g., slots, CCs, repetition factors, and/or PUCCH/PUSCH configurations) for each of a set of one or more priorities of HARQ bits. The RRC and/or MAC-CE configuration may indicate which SPS configuration or HARQ-ACK IDs to include in the codebook type 3 occasions. For example, for HARQ-ACK transmitted on PUCCH the RRC may indicate a PUCCH resource identifier, a periodicity, and one or more slot offsets (e.g., a minimum slot offset associated with threshold time 613), while for HARQ-ACK transmitted on PUSCH the RRC may indicate an index of a type-1 configured grant PUSCH that includes all parameters about the configured PUSCH transmission. In some aspects, a base station may indicate, via RRC signaling, information regarding an index of a type-2 configured grant PUSCH with a first set of parameters (e.g., waveform, DMRS configuration, etc.), and use activation DCI to signal a second set of parameters related to the PUSCH (including time domain resource allocation (TDRA), frequency domain resource allocation (FDRA), rank, etc.).

After transmitting the HARQ codebook configuration/activation 606, the network entity 602 may transmit DL transmission 608. HARQ feedback associated with DL transmissions in the set of DL transmission 608 may be missed (e.g., skipped or canceled) based on conflicts and/or collisions with other transmissions (e.g., other DL or UL transmission with higher priority). After a threshold number of HARQ occasions and/or transmissions have been missed, the network node may explicitly or implicitly receive a type-3 HARQ trigger 610. The type-3 HARQ trigger 610 may identify a HARQ resource for transmitting a one-shot and/or type-3 HARQ associated with DL transmissions in the set of DL transmissions 608. The HARQ resource identified by the type-3 HARQ trigger 610 may be used to transmit information regarding at least one DL transmission (e.g., DL transmission 608C) in the set of DL transmissions 608 that are transmitted after the type-3 HARQ trigger 610 that occur before a cutoff time 612. The cutoff time 612 may be a threshold time 613 before the resources identified by the type-3 HARQ trigger 610.

Based on the type-3 HARQ trigger 610, the network node 604 may identify, at 614, information associated with a set of canceled HARQ bits. In some aspects, the information associated with the set of canceled HARQ bits includes a HARQ ID associated with the set of canceled HARQ bits. The HARQ ID, in some aspects, may be included in a list of configured HARQ IDs to be transmitted when the HARQ bit is canceled. In some aspects, the information associated with the set of canceled HARQ bits is identified based on a triggering condition. The triggering condition, in some aspects, includes a threshold number of missed HARQ transmissions. Missed HARQ transmissions may include, in some aspects, at least skipped HARQ transmissions and canceled HARQ transmissions. In some aspects, the set of canceled HARQ bits includes at least one HARQ bit canceled after the triggering condition is met.

The network node 604 may also select, at 616, at least one CC in the plurality of CCs for transmitting the information associated with a HARQ bit in the set of canceled HARQ bits. Selecting the at least one CC, in some aspects, includes at least one of selecting a first CC for a first canceled HARQ bit associated with a first priority or selecting a second CC for a second canceled HARQ bit associated with a second priority. The first CC and the second CC, in some aspects, may be a same CC or different CCs. In some aspects, the selecting the at least one CC at 616 may include selecting one or more sets of periodic (type-3) HARQ resources in the at least one CC.

In some aspects, the network node may order and/or rank the CCs based on one or more of an eligibility of usage (within the set of periodic resources in the plurality of CCs for the HARQ codebook activated by the HARQ codebook configuration/activation 606); a proximity in time to a type-3 HARQ trigger (e.g., an implicit or explicit trigger); whether a number of available UL slots fits the configured PUCCH and/or PUSCH resource (e.g., via configured grants) associated with transmitting the information associated with the HARQ bit in the set of canceled HARQ bits. After ordering and/or ranking the CCs, the network node may select the at least one CC to transmit a high priority HARQ-ACK codebook (e.g., information regarding a set of canceled HARQ bits associated with a first priority) on a CC that contains an available PUCCH and/or PUSCH resource that is closest in time to the triggering time (but not within a threshold time necessary for preparing the transmission). Selecting the at least one CC may include selecting a number of beams via which to transmit the information associated with the HARQ bit(s) in the set of canceled HARQ bits and/or a number of different PUCCH and/or PUSCH resources associated with different times. For example, for a first canceled HARQ bit associated with a first priority, may be transmitted via a set of ‘X’ resources, a set of ‘X’ UL slots at ‘X’ different times, a set of ‘X’ beams associated with one or more UL slots, and/or a set of ‘X₁’ different UL slots and ‘X₂’ beams such that X = X₁*X₂. For a second canceled HARQ bit associated with a second priority, the information associated with the second canceled HARQ bit may be transmitted via a set of ‘Y’ resources, a set of ‘Y’ UL slots at ‘Y’ different times, a set of ‘Y’ beams associated with one or more UL slots, and/or a set of ‘Y₁’ different UL slots and ‘Y₂’ beams such that Y = Y₁*Y₂. The set of ‘Y’ UL slots associated with the second priority may be a second-closest in time to the triggering time.

The values of X, X₁, X₂, Y, Y₁, and Y₂, in some aspects, may be configured and/or reconfigured via one or more of RRC signaling, a MAC-CE, or (an activation) DCI. In some aspects, the RRC signaling, MAC-CE, or (activation) DCI may include information regarding resources (e.g., slots, CCs, repetition factors, and/or PUCCH/PUSCH configurations) for each of a set of one or more priorities of HARQ bits. The RRC and/or MAC-CE configuration may indicate which SPS configuration or HARQ-ACK IDs to include in the codebook type 3 occasions. For example, if the HARQ-ACK is transmitted on PUCCH the RRC may indicate a PUCCH resource identifier, a periodicity, and one or more slot offsets, while if the HARQ-ACK is transmitted on PUSCH the RRC may indicate an index of a type-1 configured grant PUSCH that includes all parameters about the configured PUSCH transmission. In some aspects, a base station may indicate, via RRC signaling, information regarding an index of a type-2 configured grant PUSCH with a first set of parameters (e.g., waveform, DMRS configuration, etc.), and use activation DCI to signal a second set of parameters related to the PUSCH (including time domain resource allocation (TDRA), frequency domain resource allocation (FDRA), rank, etc.).

Based on the information identified at 614 and the at least one CC selected at 616, the network node may transmit, and the network entity 602 may receive, a set of HARQ information 618 that may include the information identified at 614. In some aspects, allowing the network node 604 to determine the type-3 HARQ resources may reduce latency when compared to waiting for a network entity to send DL/UL grants to trigger a HARQ-ACK retransmission and indicate the retransmission resource, which incurs additional latency.

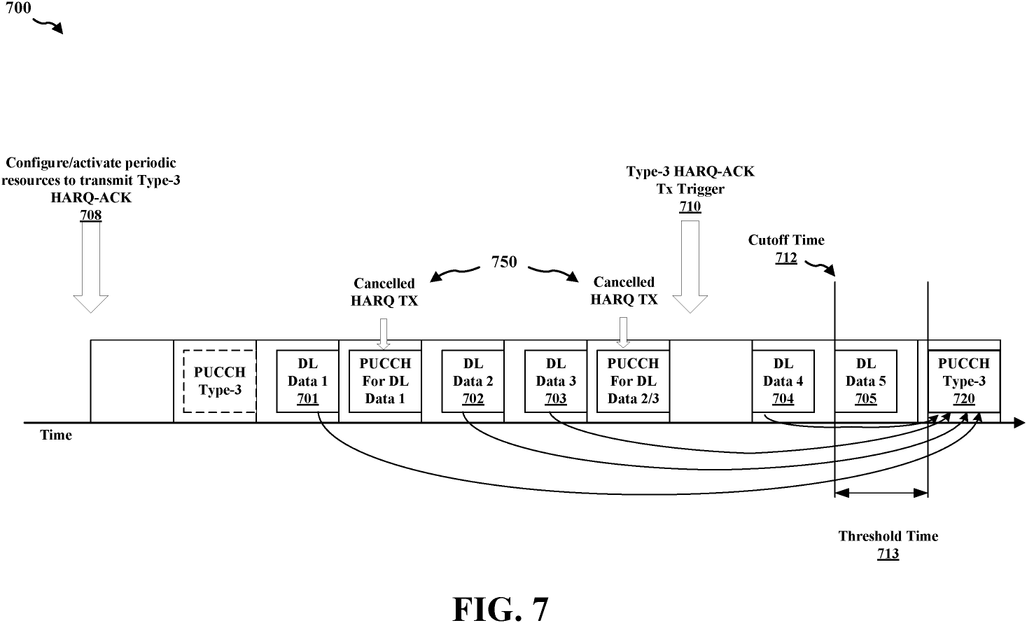

FIG. 7 is a diagram 700 illustrating a HARQ associated with a DL data that is received after a type-3 HARQ trigger 710 being transmitted in a type-3 PUCCH resource 720 associated with the type-3 HARQ trigger 710. For example, at 708 a network node may receive a configuration and/or activation for PUCCH resources including PUCCH resource 720 and a threshold or other trigger conditions. Accordingly, after having HARQ transmissions canceled, at 750, for DL data 1 701 and at least one of DL data 2 702, or DL data 3 703, the network node may receive a HARQ trigger 710 and receive additional DL data 4 704 before a cutoff time 712 and DL data 5 705 after the cutoff time (a time that is a threshold time 713 before the type-3 PUCCH resource 720). The PUCCH for DL data 1 or the PUCCH for DL data 2 or 3 may be cancelled at 750 based on being of a lower priority than another transmission scheduled for a same, or overlapping set of resources.

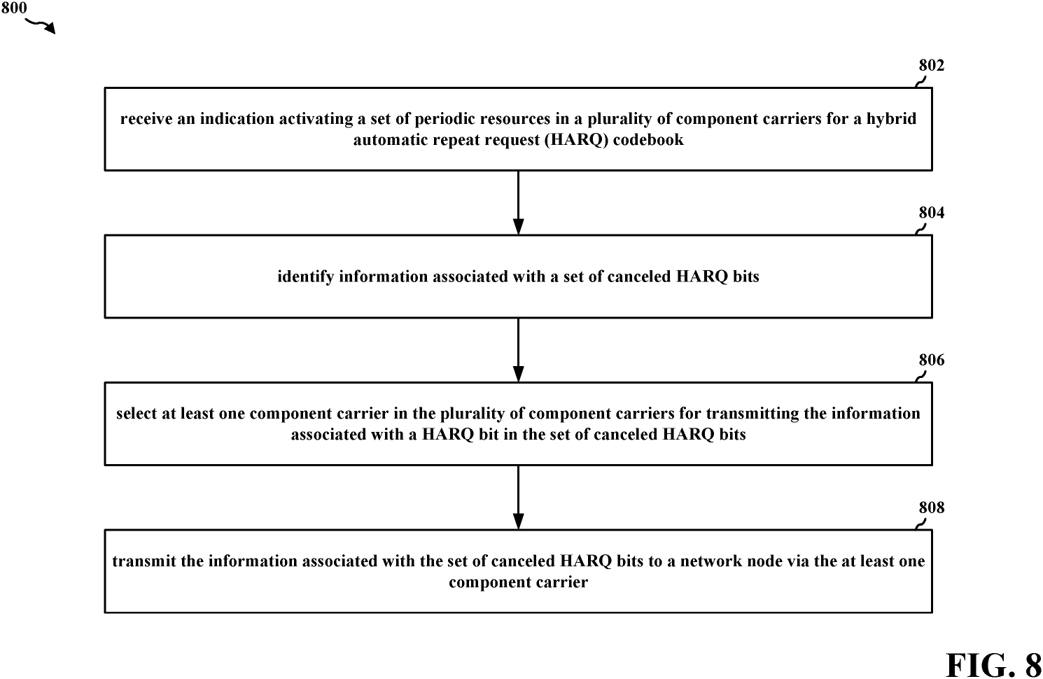

FIG. 8 is a flowchart 800 of a method of wireless communication. The method may be performed by a network node (e.g., the UE 104; network node 604; the apparatus 1004). At 802, the network node may receive an indication activating a set of periodic resources in a plurality of CCs for a HARQ codebook. For example, 802 may be performed by configured grant HARQ component 198, the application processor 1006, the cellular baseband processor 1024, the transceiver(s) 1022, and/or the antenna(s) 1080. The indication, in some aspects, may be received via at least one of RRC signaling, a MAC-CE, or DCI. For example, network node 604 may receive HARQ codebook activation 606 from the network entity 602. The activated set of periodic resources may, in some aspects, be associated with a set of data (e.g., DL transmissions).

At 804, the network node may identify information associated with a set of canceled HARQ bits. For example, 804 may be performed by configured grant HARQ component 198 and/or the application processor 1006. In some aspects, the information associated with the set of canceled HARQ bits includes a HARQ ID associated with the set of canceled HARQ bits. The HARQ ID, in some aspects, may be included in a list of configured HARQ IDs to be transmitted when the HARQ bit is canceled. In some aspects, the information associated with the set of canceled HARQ bits is identified based on a triggering condition. The triggering condition, in some aspects, includes a threshold number of missed HARQ transmissions. Missed HARQ transmissions may include, in some aspects, at least skipped HARQ transmissions and canceled HARQ transmissions. In some aspects, the set of canceled HARQ bits includes at least one HARQ bit canceled after the triggering condition is met. For example, referring to FIGS. 6 and 7, the network node 604 may identify, at 614, information associated with the set of canceled HARQ bits associated with a set of DL transmissions 608 (or DL data 1 701, DL data 2 702, and DL data 3 704 of FIG. 7).

At 806, the network node may, in some aspects, select at least one CC in the plurality of CCs for transmitting the information associated with a HARQ bit in the set of canceled HARQ bits. For example, 806 may be performed by configured grant HARQ component 198 and/or the application processor 1006. Selecting the at least one CC, in some aspects, includes selecting at least one of a first CC for a first canceled HARQ bit associated with a first priority or a second CC for a second canceled HARQ bit associated with a second priority. The first CC and the second CC, in some aspects, may be a same CC or different CCs. In some aspects, selecting the at least one CC at 806 may include selecting one or more sets of periodic (type-3) HARQ resources in the at least one CC.

In some aspects, the network node may order and/or rank the CCs based on one or more of an eligibility of usage (within the set of periodic resources in the plurality of CCs for the HARQ codebook activated by the indication received at 802); a proximity in time to a type-3 HARQ trigger (e.g., an implicit or explicit trigger); whether a number of UL slots associated with transmitting the information associated with a HARQ bit in the set of canceled HARQ bits fits the configured PUCCH and/or PUSCH resource. After ordering and/or ranking the CCs, the network node may select the at least one CC to transmit a high priority HARQ-ACK codebook (e.g., information regarding a set of canceled HARQ bits associated with a first priority) on a CC that contains an available PUCCH and/or PUSCH resource that is closest in time to the triggering time (but not within a threshold time necessary for preparing the transmission). Selecting the at least one CC may include selecting a number of beams via which to transmit the information associated with the HARQ bit(s) in the set of canceled HARQ bits and/or a number of different PUCCH and/or PUSCH resources associated with different times. For example, for a first canceled HARQ bit associated with a first priority, may be transmitted via a set of ‘X’ resources, a set of ‘X’ UL slots at ‘X’ different times, a set of ‘X’ beams associated with one or more UL slots, and/or a set of ‘X₁’ different UL slots and ‘X₂’ beams such that X = X₁*X₂. For a second canceled HARQ bit associated with a second priority, the information associated with the second canceled HARQ bit may be transmitted via a set of ‘Y’ resources, a set of ‘Y’ UL slots at ‘Y’ different times, a set of ‘Y’ beams associated with one or more UL slots, and/or a set of ‘Y₁’ different UL slots and ‘Y₂’ beams such that Y = Y₁*Y₂. The set of ‘Y’ UL slots associated with the second priority may be a second-closest in time to the triggering time.

The values of X, X₁, X₂, Y, Y₁, and Y₂, in some aspects, may be configured and/or reconfigured via one or more of RRC signaling, a MAC-CE, or (an activation) DCI. In some aspects, the RRC signaling, MAC-CE, or (activation) DCI may include information regarding resources (e.g., slots, CCs, repetition factors, and/or PUCCH/PUSCH configurations) for each of a set of one or more priorities of HARQ bits. The RRC and/or MAC-CE configuration may indicate which semi-persistent scheduling (SPS) configuration or HARQ-ACK IDs to include in the codebook type 3 occasions. For example, if the HARQ-ACK is transmitted on PUCCH the RRC may indicate a PUCCH resource identifier, a periodicity, and one or more slot offsets, while if the HARQ-ACK is transmitted on PUSCH the RRC may indicate an index of a type-1 configured grant PUSCH that includes all parameters about the configured PUSCH transmission. In some aspects, a base station may indicate, via RRC signaling, information regarding an index of a type-2 configured grant PUSCH with a first set of parameters (e.g., waveform, DMRS configuration, etc.), and use activation DCI to signal a second set of parameters related to the PUSCH (including time domain resource allocation (TDRA), frequency domain resource allocation (FDRA), rank, etc.).

At 808, the network node transmit the information associated with the set of canceled HARQ bits to a network node via the at least one component carrier. For example, 808 may be performed by configured grant HARQ component 198, the application processor 1006, the cellular baseband processor 1024, the transceiver(s) 1022, and/or the antenna(s) 1080. Transmitting the information associated with the set of canceled HARQ bits, at 808, in some aspects, includes transmitting at least one of the first canceled HARQ bit associated with the first priority via a first number (e.g., X) of beams and/or resources or the second canceled HARQ bit associated with the second priority via a second number (e.g., Y) of beams and/or resources. In some aspects, the first number X of beams is greater than the second number Y of beams. The HARQ codebook associated with transmitting the information associated with the set of canceled HARQ bits, in some aspects, is a type-3 HARQ codebook. For example, referring to FIGS. 6 and 7, the network node 604 may transmit HARQ information 618 via type-3 PUCCH resource 720.

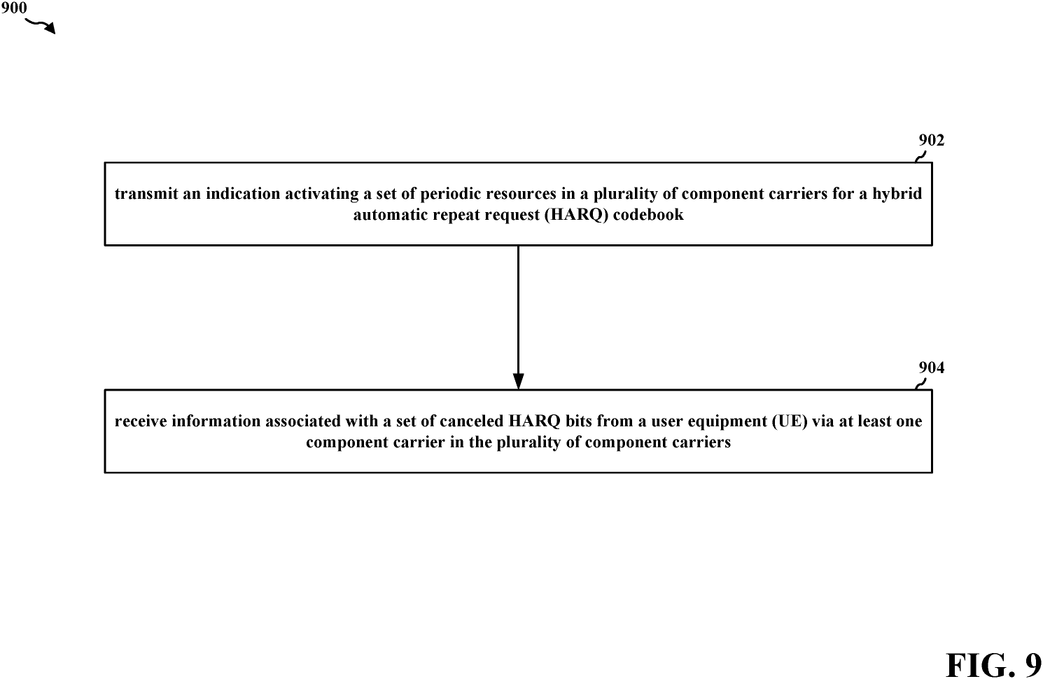

FIG. 9 is a flowchart 900 of a method of wireless communication. The method may be performed by a network node (e.g., the BS 102; network entity 602; the network entity 1102). At 902, the network node may transmit an indication activating a set of periodic resources in a plurality of component carriers for a HARQ codebook. For example, 902 may be performed by configured grant HARQ component 199, the RU processor 1142, the transceiver(s) 1146, and/or the antenna(s) 1180. The indication, in some aspects, may be transmitted via at least one of RRC signaling, a MAC-CE, or DCI. For example, referring to FIG. 6, network entity 602 may transmit HARQ codebook activation 606 to the network node 604. The activated set of periodic resources may, in some aspects, be associated with a set of data (e.g., DL transmissions). For example, the indication activating the set of periodic resources may indicate that a first canceled HARQ bit associated with a first priority may be transmitted via a set of ‘X’ resources, a set of ‘X’ UL slots at ‘X’ different times, a set of ‘X’ beams associated with one or more UL slots, and/or a set of ‘X₁’ different UL slots and ‘X₂’ beams such that X = X₁*X₂. The indication activating the set of periodic resources, in some aspects, may indicate that a second canceled HARQ bit associated with a second priority may be transmitted via a set of ‘Y’ resources, a set of ‘Y’ UL slots at ‘Y’ different times, a set of ‘Y’ beams associated with one or more UL slots, and/or a set of ‘Y₁’ different UL slots and ‘Y₂’ beams such that Y = Y₁*Y₂. The set of ‘Y’ UL slots associated with the second priority may be a second-closest in time to the triggering time.

The values of X, X₁, X₂, Y, Y₁, and Y₂, in some aspects, may be configured and/or reconfigured via one or more of RRC signaling, a MAC-CE, or (an activation) DCI. In some aspects, the RRC signaling, MAC-CE, or (activation) DCI may include information regarding resources (e.g., slots, CCs, repetition factors, and/or PUCCH/PUSCH configurations) for each of a set of one or more priorities of HARQ bits. The RRC and/or MAC-CE configuration may indicate which semi-persistent scheduling (SPS) configuration or HARQ-ACK IDs to include in the codebook type 3 occasions. For example, for HARQ-ACK transmitted on PUCCH the RRC may indicate a PUCCH resource identifier, a periodicity, and one or more slot offsets, while for HARQ-ACK transmitted on PUSCH the RRC may indicate an index of a type-1 configured grant PUSCH that includes all parameters about the configured PUSCH transmission. In some aspects, a base station may indicate, via RRC signaling, information regarding an index of a type-2 configured grant PUSCH with a first set of parameters (e.g., waveform, DMRS configuration, etc.), and use activation DCI to signal a second set of parameters related to the PUSCH (including time domain resource allocation (TDRA), frequency domain resource allocation (FDRA), rank, etc.).

At 904, the network node may receive information associated with a set of canceled HARQ bits from a network node (e.g., a UE) via at least one component carrier in the plurality of component carriers. For example, 904 may be performed by configured grant HARQ component 199, the RU processor 1142, the transceiver(s) 1146, and/or the antenna(s) 1180. In some aspects, the information associated with the set of canceled HARQ bits includes a HARQ ID associated with the set of canceled HARQ bits. The HARQ ID, in some aspects, may be included in a list of configured HARQ IDs to be transmitted when the HARQ bit is canceled. In some aspects, the information associated with the set of canceled HARQ bits is identified based on a triggering condition. The triggering condition, in some aspects, includes a threshold number of missed HARQ transmissions. Missed HARQ transmissions may include, in some aspects, at least skipped HARQ transmissions and canceled HARQ transmissions. In some aspects, the set of canceled HARQ bits includes at least one HARQ bit canceled after the triggering condition is met. For example, referring to FIGS. 6 and 7, the network node 604 may receive, at 618, information associated with the set of canceled HARQ bits associated with a set of DL transmissions 608 (or DL data 1 701, DL data 2 702, DL data 3 703, and DL data 4 704 of FIG. 7).

Receiving the information associated with the set of canceled HARQ bits, at 904, in some aspects, includes at least one of receiving the first canceled HARQ bit associated with the first priority via a first number (e.g., X) of beams and/or resources or transmitting the second canceled HARQ bit associated with the second priority via a second number (e.g., Y) of beams and/or resources. In some aspects, the first number X of beams is greater than the second number Y of beams. The information associated with the set of canceled HARQ bits, in some aspects, may include a set of HARQ IDs associated with the set of canceled HARQ bits and a set of HARQ bit values associated with the set of canceled HARQ bits. The HARQ codebook associated with receiving the information associated with the set of canceled HARQ bits, in some aspects, is a type-3 HARQ codebook. For example, referring to FIGS. 6 and 7, the network entity 602 may receive HARQ information 618 via type-3 PUCCH resources720.

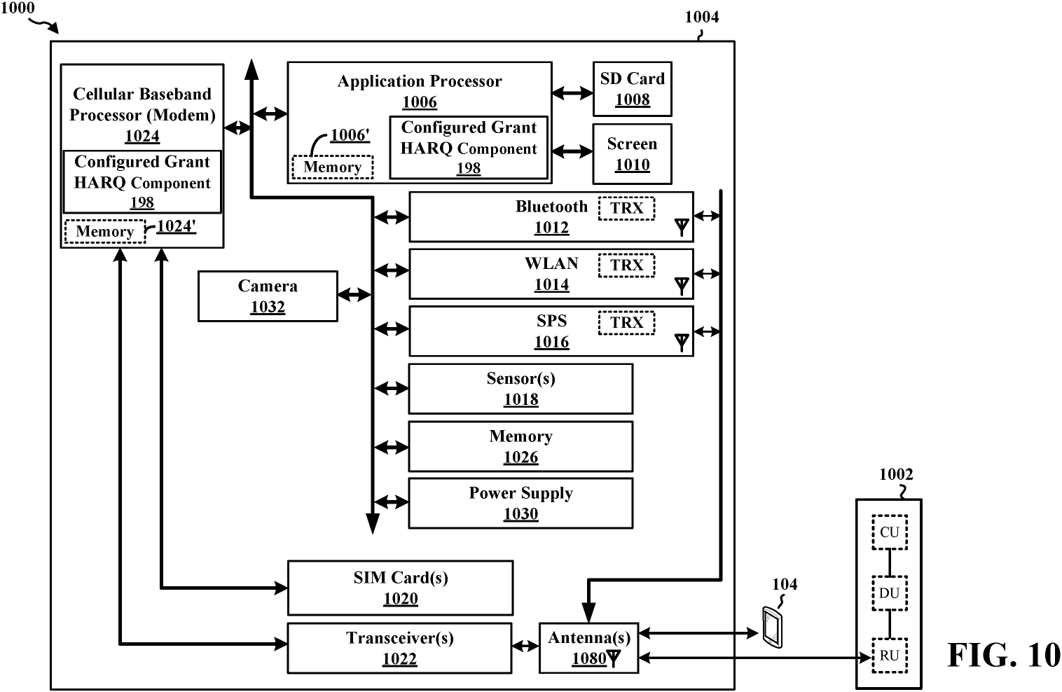

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor / altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium / memory 1024′, 1006′, respectively. The additional memory modules 1026 may also be considered a computer-readable medium / memory. Each computer-readable medium / memory 1024′, 1006′, 1026 may be non-transitory. The cellular baseband processor 1024 and the application processor 1006 are each responsible for general processing, including the execution of software stored on the computer-readable medium / memory. The software, when executed by the cellular baseband processor 1024 / application processor 1006, causes the cellular baseband processor 1024 / application processor 1006 to perform the various functions described supra. The computer-readable medium / memory may also be used for storing data that is manipulated by the cellular baseband processor 1024 / application processor 1006 when executing software. The cellular baseband processor 1024 / application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed supra, the configured grant HARQ component 198 is configured to receive an indication activating a set of periodic resources in a plurality of CCs for a HARQ codebook, identify information associated with a set of canceled HARQ bits, select at least one CC in the plurality of CCs for transmitting the information associated with a HARQ bit in the set of canceled HARQ bits, and transmit the information associated with the set of canceled HARQ bits to a network node via the at least one CC. The configured grant HARQ component 198 may be within the cellular baseband processor 1024, the application processor 1006, or both the cellular baseband processor 1024 and the application processor 1006. The configured grant HARQ component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for receiving an indication activating a set of periodic resources in a plurality of component carriers for a HARQ codebook; means for identifying information associated with a set of canceled HARQ bits; means for selecting at least one component carrier in the plurality of component carriers for transmitting the information associated with a HARQ bit in the set of canceled HARQ bits; and means for transmitting the information associated with the set of canceled HARQ bits to a network node via the at least one component carrier. The means may be the configured grant HARQ component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

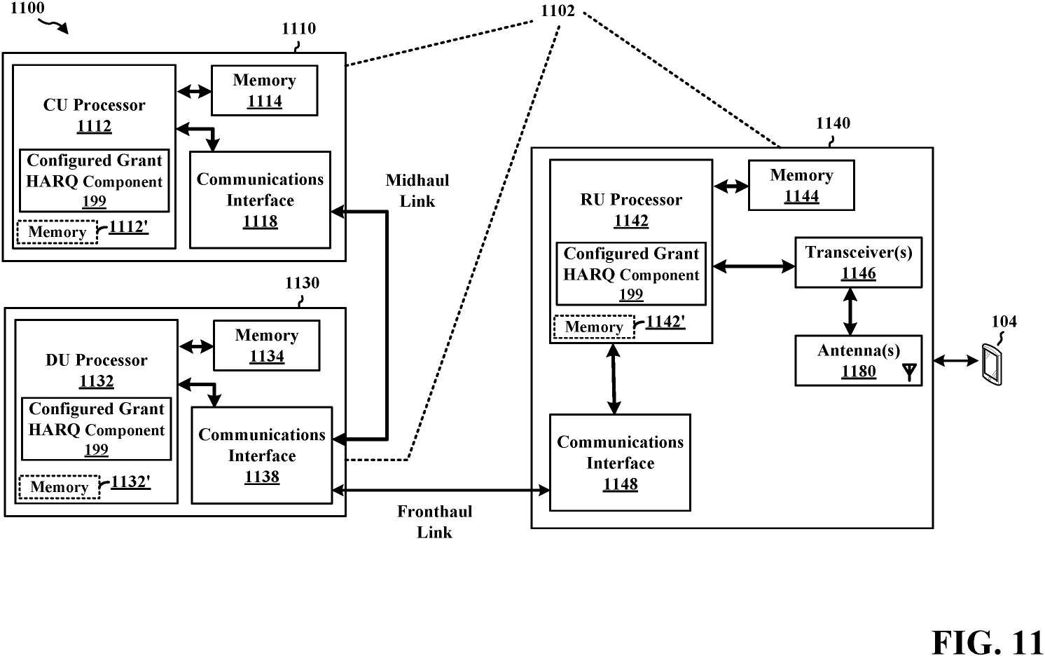

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the configured grant HARQ component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium / memory. Each computer-readable medium / memory may be non-transitory. Each of the processors 1112, 1132, 1142 is responsible for general processing, including the execution of software stored on the computer-readable medium / memory. The software, when executed by the corresponding processor(s) causes the processor(s) to perform the various functions described supra. The computer-readable medium / memory may also be used for storing data that is manipulated by the processor(s) when executing software.

As discussed supra, the configured grant HARQ component 199 is configured to transmit an indication activating a set of periodic resources in a plurality of CCs for a HARQ codebook and receive information associated with a set of canceled HARQ bits from a network node (e.g., a UE) via at least one CC in the plurality of CCs. The configured grant HARQ component 199 may be within one or more processors of one or more of the CU 1110, DU 1130, and the RU 1140. The configured grant HARQ component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for transmitting an indication activating a set of periodic resources in a plurality of component carriers for a HARQ codebook and means for receiving information associated with a set of canceled HARQ bits from a UE via at least one component carrier in the plurality of component carriers. The means may be the configured grant HARQ component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects, of wireless communication a mechanism or method for HARQ-ACK feedback may be implemented that allows for a network entity to request feedback of a HARQ-ACK codebook containing all DL HARQ processes (e.g., one-shot feedback) for all CCs configured for a UE in the PUCCH group. In some aspects, the mechanism allows the network entity to recover information related to one or more failed HARQ-ACK feedback transmissions due to listen -before-talk (LBT) based failures. Similarly, in the presence of different types of feedback and other transmissions with different priorities canceled feedback transmissions become more frequent. However, different types of communications, e.g., URLLC, may specify low latency that may not be achieved by request-based feedback from a network entity (e.g., a base station) that first identifies that feedback was not received and then may make a request for the feedback. Accordingly, the apparatus and method presented herein provides a mechanism for reducing the latency of the identification and selection of resources associated with missed HARQ feedback.

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a network node, including a memory and at least one processor coupled to the memory and, based at least in part on information stored in the memory, the at least one processor is configured to: receive an indication activating a set of periodic resources in a plurality of component carriers for a HARQ codebook, identify first information associated with a set of canceled HARQ bits, select at least one component carrier in the plurality of component carriers for transmitting the first information associated with a HARQ bit in the set of canceled HARQ bits, and transmit the first information associated with the set of canceled HARQ bits to a network node via the at least one component carrier.

Aspect 2 is the apparatus of aspect 1, where the indication is received via at least one of RRC signaling, a MAC-CE, or DCI.

Aspect 3 is the apparatus of any of aspects 1 and 2, where the first information associated with the set of canceled HARQ bits includes a HARQ ID associated with the set of canceled HARQ bits, where the HARQ ID is included in a list of configured HARQ IDs to be transmitted when the HARQ bit is canceled.

Aspect 4 is the apparatus of any of aspects 1 to 3, where the first information associated with the set of canceled HARQ bits is identified based on a triggering condition.

Aspect 5 is the apparatus of aspect 4, where the triggering condition includes a threshold number of missed HARQ transmissions, where missed HARQ transmissions include at least skipped HARQ transmissions and canceled HARQ transmissions.

Aspect 6 is the apparatus of any of aspects 4 and 5, where the set of canceled HARQ bits includes at least one HARQ bit canceled after the triggering condition is met.

Aspect 7 is the apparatus of any of aspects 1 to 6, where selecting the at least one component carrier includes at least one of selecting a first component carrier for a first canceled HARQ bit associated with a first priority or selecting a second component carrier for a second canceled HARQ bit associated with a second priority.

Aspect 8 is the apparatus of aspect 7, where transmitting the first information associated with the set of canceled HARQ bits includes at least one of transmitting the first canceled HARQ bit associated with the first priority via a first number of beams or transmitting the second canceled HARQ bit associated with the second priority via a second number of beams.

Aspect 9 is the apparatus of aspect 8, the first number of beams is greater than the second number of beams.

Aspect 10 is the apparatus of any of aspects 1 to 9, where the first information associated with the set of canceled HARQ bits includes a set of HARQ IDs associated with the set of canceled HARQ bits and a set of HARQ bit values associated with the set of canceled HARQ bits.

Aspect 11 is the apparatus of any of aspects 1 to 10, where the HARQ codebook associated with transmitting the information associated with the set of canceled HARQ bits is a type-3 HARQ codebook.

Aspect 12 is an apparatus for wireless communication at a network node, including a memory and at least one processor coupled to the memory and, based at least in part on information stored in the memory, the at least one processor is configured to: transmit an indication activating a set of periodic resources in a plurality of component carriers for a HARQ codebook and receive first information associated with a set of canceled HARQ bits from a second network node via at least one component carrier in the plurality of component carriers.

Aspect 13 is the apparatus of aspect 12, where the indication is transmitted via at least one of RRC signaling, a MAC-CE, or DCI.

Aspect 14 is the apparatus of any of aspects 12 and 13, where the first information associated with the set of canceled HARQ bits includes a HARQ ID associated with the set of canceled HARQ bits, where the HARQ ID is included in a list of configured HARQ IDs.

Aspect 15 is the apparatus of any of aspects 12 to 14, where the first information associated with the set of canceled HARQ bits is received based on a triggering condition.

Aspect 16 is the apparatus of aspect 15, where the triggering condition includes a threshold number of missed HARQ transmissions, where missed HARQ transmissions include at least skipped HARQ transmissions and canceled HARQ transmissions.

Aspect 17 is the apparatus of any of aspects 15 and 16, where the set of canceled HARQ bits includes at least one HARQ bit canceled after the triggering condition is met.

Aspect 18 is the apparatus of any of aspects 12 to 17, where the at least one component carrier is associated with at least one of a first component carrier for a first canceled HARQ bit associated with a first priority or a second component carrier for a second canceled HARQ bit associated with a second priority.

Aspect 19 is the apparatus of aspect 18, where to receive the first information associated with the set of canceled HARQ bits, the at least one processor is configured to receive at least one of the first canceled HARQ bit associated with the first priority via a first number of beams or the second canceled HARQ bit associated with the second priority via a second number of beams.

Aspect 20 is the apparatus of any of aspects 18 and 19, the first number of beams is greater than the second number of beams.

Aspect 21 is the apparatus of any of aspects 12 to 20, where the first information associated with the set of canceled HARQ bits includes a set of HARQ IDs associated with the set of canceled HARQ bits and a set of HARQ bit values associated with the set of canceled HARQ bits.

Aspect 22 is the apparatus of any of aspects 12 to 21, where the HARQ codebook associated with receiving the first information associated with the set of canceled HARQ bits is a type-3 HARQ codebook.

Aspect 23 is a method of wireless communication for implementing any of aspects 1 to 22.

Aspect 24 is an apparatus for wireless communication including means for implementing any of aspects 1 to 22.

Aspect 25 is a computer-readable medium storing computer executable code, where the code when executed by a processor causes the processor to implement any of aspects 1 to 22.

What is claimed is:

1. An apparatus for wireless communication at a first network node, comprising:
a memory:
at least one processor coupled to the memory and, based at least in part on information stored in the memory, the at least one processor is configured to:
receive an indication activating a set of periodic resources in a plurality of component carriers for a hybrid automatic repeat request (HARQ) codebook;
identify first information associated with a set of canceled HARQ bits;
select at least one component carrier in the plurality of component carriers for transmitting the first information associated with a HARQ bit in the set of canceled HARQ bits; and
transmit the first information associated with the set of canceled HARQ bits to a second network node via the at least one component carrier.

2. The apparatus of claim 1, wherein the indication is received via at least one of radio resource control (RRC) signaling, a medium access control (MAC) control element (MAC-CE), or downlink control information (DCI).

3. The apparatus of claim 1, wherein the first information associated with the set of canceled HARQ bits comprises a HARQ identifier (ID) associated with the set of canceled HARQ bits, wherein the HARQ ID is included in a list of configured HARQ IDs to be transmitted when the HARQ bit is canceled.

4. The apparatus of claim 1, wherein the first information associated with the set of canceled HARQ bits is identified based on a triggering condition.

5. The apparatus of claim 4, wherein the triggering condition comprises a threshold number of missed HARQ transmissions, wherein missed HARQ transmissions comprise at least skipped HARQ transmissions and canceled HARQ transmissions.

6. The apparatus of claim 4, wherein the set of canceled HARQ bits includes at least one HARQ bit canceled after the triggering condition is met.

7. The apparatus of claim 1, wherein to select the at least one component carrier, the at least one processor is configured to: select at least one of a first component carrier for a first canceled HARQ bit associated with a first priority or a second component carrier for a second canceled HARQ bit associated with a second priority.

8. The apparatus of claim 7, wherein to transmit the first information associated with the set of canceled HARQ bits, the at least one processor is configured to: transmit at least one of the first canceled HARQ bit associated with the first priority via a first number of beams or the second canceled HARQ bit associated with the second priority via a second number of beams.

9. The apparatus of claim 8, wherein the first number of beams is greater than the second number of beams.

10. The apparatus of claim 1, wherein the first information associated with the set of canceled HARQ bits includes a set of HARQ identifiers (IDs) associated with the set of canceled HARQ bits and a set of HARQ bit values associated with the set of canceled HARQ bits.

11. The apparatus of claim 1, wherein the HARQ codebook associated with transmitting the information associated with the set of canceled HARQ bits is a type-3 HARQ codebook.

12. An apparatus for wireless communication at a first network node, comprising:
a memory:
at least one processor coupled to the memory and, based at least in part on information stored in the memory, the at least one processor is configured to:
transmit an indication activating a set of periodic resources in a plurality of component carriers for a hybrid automatic repeat request (HARQ) codebook; and
receive first information associated with a set of canceled HARQ bits from a second network node via at least one component carrier in the plurality of component carriers.

13. The apparatus of claim 12, wherein the indication is transmitted via at least one of radio resource control (RRC) signaling, a medium access control (MAC) control element (MAC-CE), or downlink control information (DCI).

14. The apparatus of claim 12, wherein the first information associated with the set of canceled HARQ bits comprises a HARQ identifier (ID) associated with the set of canceled HARQ bits, wherein the HARQ ID is included in a list of configured HARQ IDs.

15. The apparatus of claim 12, wherein the first information associated with the set of canceled HARQ bits is received based on a triggering condition.

16. The apparatus of claim 15, wherein the triggering condition comprises a threshold number of missed HARQ transmissions, wherein missed HARQ transmissions comprise at least skipped HARQ transmissions and canceled HARQ transmissions.

17. The apparatus of claim 15, wherein the set of canceled HARQ bits includes at least one HARQ bit canceled after the triggering condition is met.

18. The apparatus of claim 12, wherein the at least one component carrier is associated with at least one of a first component carrier for a first canceled HARQ bit associated with a first priority or a second component carrier for a second canceled HARQ bit associated with a second priority.

19. The apparatus of claim 18, wherein to receive the first information associated with the set of canceled HARQ bits, the at least one processor is configured to: receive at least one of the first canceled HARQ bit associated with the first priority via a first number of beams or the second canceled HARQ bit associated with the second priority via a second number of beams.

20. The apparatus of claim 19, wherein the first number of beams is greater than the second number of beams.

21. The apparatus of claim 12, wherein the first information associated with the set of canceled HARQ bits includes a set of HARQ identifiers (IDs) associated with the set of canceled HARQ bits and a set of HARQ bit values associated with the set of canceled HARQ bits.

22. The apparatus of claim 12, wherein the HARQ codebook associated with receiving the first information associated with the set of canceled HARQ bits is a type-3 HARQ codebook.

23. A method of wireless communication at a first network node, comprising:
receiving an indication activating a set of periodic resources in a plurality of component carriers for a hybrid automatic repeat request (HARQ) codebook;
identifying information associated with a set of canceled HARQ bits;
selecting at least one component carrier in the plurality of component carriers for transmitting the information associated with a HARQ bit in the set of canceled HARQ bits; and
transmitting the information associated with the set of canceled HARQ bits to a second network node via the at least one component carrier.

24. The method of claim 23, wherein the information associated with the set of canceled HARQ bits is identified based on a triggering condition, wherein the triggering condition comprises a threshold number of missed HARQ transmissions, wherein missed HARQ transmissions comprise at least skipped HARQ transmissions and canceled HARQ transmissions.

25. The method of claim 23, selecting the at least one component carrier comprises selecting at least one a first component carrier for a first canceled HARQ bit associated with a first priority or a second component carrier for a second canceled HARQ bit associated with a second priority.

26. The method of claim 25, wherein transmitting the information associated with the set of canceled HARQ bits comprises transmitting at least one of the first canceled HARQ bit associated with the first priority via a first number of beams or the second canceled HARQ bit associated with the second priority via a second number of beams.

27. A method of wireless communication at a first network node, comprising:
transmitting an indication activating a set of periodic resources in a plurality of component carriers for a hybrid automatic repeat request (HARQ) codebook; and
receiving information associated with a set of canceled HARQ bits from a second network node via at least one component carrier in the plurality of component carriers.

28. The method of claim 27, wherein the information associated with the set of canceled HARQ bits is received based on a triggering condition, wherein the triggering condition comprises a threshold number of missed HARQ transmissions, wherein missed HARQ transmissions comprise at least skipped HARQ transmissions and canceled HARQ transmissions.

29. The method of claim 27, wherein the at least one component carrier is associated with at least one of a first component carrier for a first canceled HARQ bit associated with a first priority or a second component carrier for a second canceled HARQ bit associated with a second priority.

30. The method of claim 29, wherein receiving the information associated with the set of canceled HARQ bits comprises receiving at least one of the first canceled HARQ bit associated with the first priority via a first number of beams or the second canceled HARQ bit associated with the second priority via a second number of beams.
